(19) United States
(12) Patent Application Publication
(10) Pub. No.: US 2022/0398521 A1
(43) Pub. Date: Dec. 15, 2022

(54) METHOD AND SYSTEM FOR TIME LAG IDENTIFICATION IN AN INDUSTRY

(71) Applicant: Tata Consultancy Services Limited, Mumbai (IN)

(72) Inventors: RAJAN KUMAR, Pune (IN); MANENDRA SINGH PARIHAR, Pune (IN); VIVEK KUMAR, Pune (IN); VENKATARAMANA RUNKANA, Pu (IN)

(73) Assignee: Tata Consultancy Services Limited, Mumbai (IN)

(21) Appl. No.: 17/756,117

(22) PCT Filed: Aug. 28, 2020
(86) PCT No.: PCT/IN20/50751

§ 371 Date: May 17, 2022

(30) Foreign Application Priority Data
Jan. 29, 2020 (IN) 202021004042

(51) Int. Cl. G06Q 10/06; G06N 5/02

(52) U.S. Cl. CPC G06Q 10/06393; G06N 5/022

(57) ABSTRACT

This disclosure relates generally to for time lag identification in an industry. The disclosure proposes to monitor an industry continuously at real time to identify one or more parameters from plurality of sources (processes/units/plants) and a time delay or delayed performance or functional impact the identified parameter has on a plurality of Key Performance Indicator (KPI). The proposed time lag identification is performed using one-time lag identification from the proposed plurality of time lag identification techniques that include an individual time lag identification technique, a group-wise time lag identification technique and group-wise/individual time lag identification technique. Further the time lag identification is performed based on domain knowledge as well as data driven techniques. The identified time-lag is used for prediction and forecasting or detection of anomalies in process and manufacturing industries

### CROSS-REFERENCE TO RELATED APPLICATIONS AND PRIORITY

The present application claims priority from Indian provisional patent application no.202021004042, filed on Jan. 29, 2020.

### TECHNICAL FIELD

The disclosure herein generally relates to field of time lag identification in industries and, more particularly, to identification of one or more parameters and the time lag or delayed performance or functional impact the identified parameter has on a plurality of Key Performance Indicator (KPI) in industries.

### BACKGROUND

The systems in different industries/manufacturing units are designed to operate in desired efficient range based on identification & monitoring of Key Performance Indicator (KPI) that gives maximum functional efficiency for that industries/manufacturing units. The KPIs include but not limited to productivity, specific energy consumption, fuel consumption, product quality, emergency work, mean time between failures.

The desired operational range of KPIs are dependent on are multiple factors/parameters as the industries/manufacturing units comprise of one or more sources that further comprises a plurality of processes, wherein each of the plurality of processes comprises a plurality of units. These units and processes may or may not instantly impact the KPIs, wherein a few parameters may have a delayed impact on functioning of the KPIs that can be termed as time lag, wherein the time lags include parameters like processing time, reaction time, transportation lag from one unit to other units, response time of sensors, residence time of raw materials at yards, etc. Hence for an industry to operate in desired efficient range it is important to identify the time lags & the parameters that could cause a time lag effect on KPIs.

The existing techniques for time lag identification can handle single parameters from same plants/units and may not be very effective in handling variables/parameters of different sampling frequencies and timestamps from different plants & units. Also, existing time lag identification is performed based on either one of domain knowledge or physics-based models of data driven techniques developed from industrial data using various machine learning or statistical models.

### SUMMARY

Embodiments of the present disclosure present technological improvements as solutions to one or more of the above-mentioned technical problems recognized by the inventors in conventional systems. For example, in one embodiment, a method and a system for time lag identification in an industry is provided. The disclosure proposes to monitor an industry continuously at real time to identify at least one or more parameters from plurality of sources (processes/units/plants) and a time delay or delayed performance or functional impact that the identified parameter has on a plurality of Key Performance Indicator (KPI). The proposed time lag identification is performed using one-time lag identification from the proposed plurality of time lag identification techniques that include an individual time lag identification technique, a group-wise time lag identification technique and group-wise/individual time lag identification technique. Further the time lag identification is performed based on domain knowledge as well as data driven techniques.

In another aspect, a method for time lag identification in an industry is provided. The method includes receiving a plurality of data as an input from one or more sources, wherein the plurality of data comprises a plurality of input parameters and each of the one or more sources comprises a plurality of plants, wherein each of the plurality of plants comprises a plurality of units. The method further includes pre-processing the received plurality of data. The method further includes identifying presence of groups among the plurality of pre-processed data based on a plurality of domain knowledge and a plurality of data-based techniques. The method further includes selecting a set of parameters from the grouped plurality of data based on the domain knowledge using a plurality of feature selection techniques, wherein the selected set of parameters are represented as numerical data. The method further includes identifying at least one time lag parameter from the selected set of parameters based on at least one of a plurality of time lag identification techniques that are selected based a user requirement, wherein the plurality of time lag identification techniques are an individual time lag identification technique, a group-wise time lag identification technique and group-wise/individual time lag identification technique. The method further includes displaying the identified time lag parameter on a display module, wherein the identified lag parameter represents time lag identification in the industry.

In another aspect, a system for time lag identification in an industry is provided. The system comprises an input module configured an input module configured for receiving a plurality of data as an input from one or more sources, wherein the plurality of data comprises a plurality of input parameters and each of the one or more sources comprises a plurality of plants, wherein each of the plurality of plants comprises a plurality of unit. The system further includes a pre-processing module configured for pre-processing the received plurality of data. The system further includes a grouping module configured for identifying presence of groups among the plurality of pre-processed data based on a plurality of domain knowledge and a plurality of data-based techniques. The system further includes a feature selection module configured for selecting a set of parameters from the grouped plurality of data based on the domain knowledge and data-based techniques using feature selection techniques, wherein the selected set of parameters are represented as numerical data. The system further includes a time lag identification module identifying at least one time lag parameter from the selected set of parameters based on at least one of a plurality of time lag identification techniques that are selected based a user requirement, wherein the plurality of time lag identification techniques are an individual time lag identification technique, a group-wise time lag identification technique and group-wise/individual time lag identification technique. The system further includes a display module configured for displaying the identified time lag parameter on a display module, wherein the identified time lag parameter represents time lag identification in the industry.

In yet another aspect, a non-transitory computer readable medium for time lag identification in an industry is provided. The program includes receiving a plurality of data as an input from one or more sources, wherein the plurality of data comprises a plurality of input parameters and each of the one or more sources comprises a plurality of plants, wherein each of the plurality of plants comprises a plurality of units. The program further includes pre-processing the received plurality of data. The program further includes identifying presence of groups among the plurality of pre-processed data based on a plurality of domain knowledge and a plurality of data-based techniques. The program further includes selecting a set of parameters from the grouped plurality of data based on the domain knowledge using a plurality of feature selection techniques, wherein the selected set of parameters are represented as numerical data. The program further includes identifying at least one time lag parameter from the selected set of parameters based on at least one of a plurality of time lag identification techniques that are selected based a user requirement, wherein the plurality of time lag identification techniques are an individual time lag identification technique, a group-wise time lag identification technique and group-wise/individual time lag identification technique. The program further includes displaying the identified time lag parameter on a display module, wherein the identified lag parameter represents time lag identification in the industry.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary block diagram of a system for time lag identification (time lag identifier) in an industry along with the plurality of input sources in accordance with some embodiments of the present disclosure.

FIG. 2 is a functional block diagram of various modules stored in the system (time lag identifier) of FIG. 1 in accordance with some embodiments of the present disclosure.

FIG. 3 is a use case example of identifying groups for pre-processed data based on a plurality of domain knowledge and a plurality of data-based techniques in accordance with some embodiments of the present disclosure.

FIG. 4 is an exemplary flow diagram for the steps of individual time lag identification technique according to some embodiments of the present disclosure.

FIG. 5 is an exemplary flow diagram for the steps of individual time lag identification technique according to some embodiments of the present disclosure.

FIG. 6 is an exemplary flow diagram for the steps of ensemble feature selection techniques according to some embodiments of the present disclosure.

FIG. 7 is an exemplary flow diagram for the steps of group-wise/individual time lag identification technique according to some embodiments of the present disclosure.

FIG. 8A and FIG. 8B is an exemplary flow diagram for time lag identification (time lag identifier) in an industry according to some embodiments of the present disclosure.

FIG. 9 is a use case example illustration for displaying the identified time lag parameter on a display module.

### DETAILED DESCRIPTION OF EMBODIMENTS

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

The disclosure proposes for time lag identification in an industry is provided. The disclosure proposes to monitor an industry continuously at real time to identify at least one or more parameters from plurality of sources (processes/units/plants) and a time delay or delayed performance or functional impact the identified parameter has on a plurality of Key Performance Indicator (KPIs), wherein a parameter that causes even zero time delay is also identified and monitored. The Key performance indicators (KPIs) are a quantifiable measure used to evaluate the success of a system/process/industrial plant/organization against meeting objectives for performance. The desired operational range of KPIs are dependent on are multiple factors/parameters as the industries/manufacturing units comprise of one or more sources that further comprises a plurality of processes, wherein each of the plurality of processes comprises a plurality of units. These units and processes may or may not instantly impact the KPIs, wherein a few parameters may have a delayed impact on functioning of the KPIs that can be termed as time lag. The proposed time lag identification is performed using one-time lag identification from the proposed plurality of time lag identification techniques that include an individual time lag identification technique, a group-wise time lag identification technique and group-wise/individual time lag identification technique. Further the time lag identification is performed based on domain knowledge as well as data driven techniques. The identified time-lag is used for prediction and forecasting or detection of anomalies in process and manufacturing industries

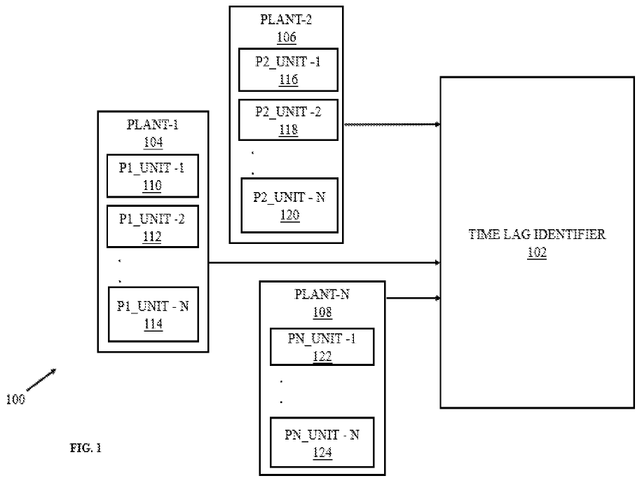

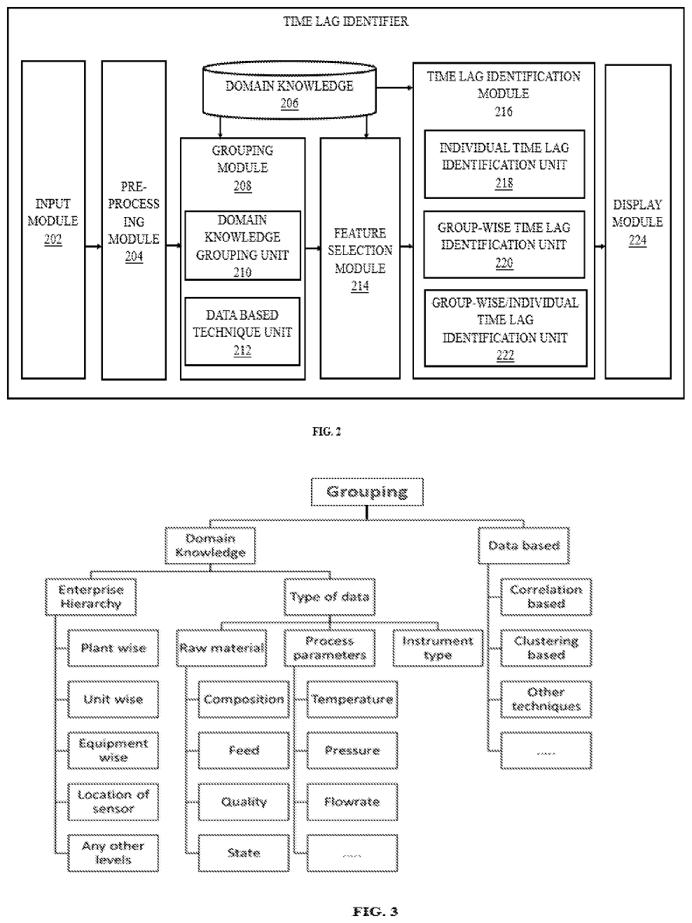

Referring now to the drawings, and more particularly to FIG. 1 through FIG. 9, where similar reference characters denote corresponding features consistently throughout the figures, there are shown preferred embodiments and these embodiments are described in the context of the following exemplary system and/or method.

FIG. 1 is a block diagram of a system 100 for time lag identification in an industry along with the plurality of input sources, in accordance with an example embodiment.

The system 100 includes a time lag identifier (102) for identification of time lag identification. The time lag identification refers to identification of one or more parameters and a time delay or delayed performance or functional impact the identified parameter has on a plurality of Key Performance Indicator (KPI) and comprises of a plurality of parameters that include processing time, reaction time, transportation lag from one unit to other units, response time of sensors, residence time of raw materials at yards. The time lag identifier (102) receives a plurality of data as an input from one or more sources, wherein the plurality of data comprises a plurality of input parameters and each of the one or more sources comprises a plurality of plants represented by a plant-1(104), a plant-2(106) and a plant-3(108) in FIG. 1. Further each of the plurality of processes comprises a plurality of units represented by a P1_Unit-1(110), a P1_Unit-1(112), a PN_Unit-1(114) for the process-1(104), a P2_Unit-1(116), a P2_Unit-2(118), a PN_Unit-N(120) for the process-2(106) and a PN_Unit-1(122), a PN_Unit-N(124) for the process-N(108).

In an embodiment, considering an use case example of a blast furnace, the data like raw materials quality and composition, process parameters, product quality, production amount, effluents etc. are received as input from a plurality of plants that include raw material bedding and blending, coke plant, sinter plant, pellet plant etc. Further, the said plants comprise plurality of units that include 6 coke plants, 3 sinter plants, 2 pellet plants.

FIG. 2, with reference to FIG. 1, is a block diagram of various modules of time lag identifier (102) of the system 100 of FIG. 1 in accordance with an embodiment of the present disclosure. In an embodiment of the present disclosure, the system (100) comprises an input module (202) configured for receiving a plurality of data as an input from one or more sources, wherein the plurality of data comprises a plurality of input parameters and each of the one or more sources comprises a plurality of plants, wherein each of the plurality of plants comprises a plurality of units. The time lag identifier (102) of system 100 further comprises a pre-processing module (204) configured for pre-processing the received plurality of data. The time lag identifier (102) of system 100 further comprises a plurality of domain knowledge is obtained from a domain knowledge (206) database that is configured for sharing dynamically updated domain knowledge of an industry for which time lag is being identified. The time lag identifier (102) of system 100 further comprises a grouping module (208) configured for identifying presence of groups among the plurality of pre-processed data based on a plurality of domain knowledge and a plurality of data based techniques and the grouping module (208) further comprises of an domain knowledge grouping unit (210) configured for identifying the presence of groups among the plurality of pre-processed data based on a plurality of domain knowledge that is received from the domain knowledge (206) database and a data based technique unit (212) configured for identifying the presence of groups among the plurality of pre-processed data based a plurality of data based techniques. The time lag identifier (102) of system 100 further comprises a feature selection module (214) configured for selecting a set of parameters from the grouped plurality of data based on the domain knowledge and data based techniques using feature selection techniques, wherein the selected set of parameters are represented as numerical data. The time lag identifier (102) of system 100 further comprises a time lag identification module (216) identifying at least one time lag parameter from the selected set of parameters based on at least one of a plurality of time lag identification techniques that are selected based a user requirement, wherein the plurality of time lag identification techniques are an individual time lag identification technique, a group-wise time lag identification technique and group-wise/individual time lag identification technique. The time lag identification module (216) further comprises of an individual time lag identification unit (218) configured for individual time lag identification, a group-wise time lag identification unit (220) configured for the group-wise time lag identification and a group-wise/individual time lag identification unit (222) configured for the group-wise/individual time lag identification. The time lag identifier (102) of system 100 further comprises a display module (224) configured for displaying the identified time lag parameter on a display module, wherein the identified time lag parameter represents time lag identification in the industry. The various modules of time lag identifier (102) of system 100 that are implemented as at least one of a logically self-contained part of a software program, a self-contained hardware component, and/or, a self-contained hardware component with a logically self-contained part of a software program embedded into each of the hardware component that when executed perform the above method described herein.

According to an embodiment of the disclosure, the time lag identifier (102) of system 100 comprises the input module (202) configured for receiving a plurality of data as an input from one or more sources, wherein the plurality of data comprises a plurality of input parameters and each of the one or more sources comprises a plurality of plants, wherein each of the plurality of plants comprises a plurality of units as shown in FIG. 1. The received data from one or more sources comprise a plurality of parameters that include raw materials quality-composition, process parameters, product quality, production amount, equipment condition and effluents for each source, plant or unit.

According to an embodiment of the disclosure, the time lag identifier (102) of system 100 further comprises the pre-processing module (204) that is configured for pre-processing the received plurality of input data and the plurality of real-time input data. In an embodiment step of pre-processing includes removing outliers and replacing missing input data based on multi-level outlier model and clustering classification respectively.

In one embodiment, the pre-processing includes performing iterations for pre-processing input data associated with a manufacturing process. Each iteration comprises removing outliers from the input data using a multi-level outlier model to obtain a filtered data. The filtered data is categorized into multiple categories to identify missing data based on a frequency of occurrence of various parameters. Missing data is selectively imputed based on the multiple categories to obtain imputed data which is clustered into various data clusters based on a pre-defined criterion. After every iteration, it is determined whether the imputed data associated with a current iteration is clustered into the same data clusters as associated with a previous iteration. Various iterations are performed until the data clusters in the previous iteration and the current iterations are similar to finally result in pre-processed input data.

According to an embodiment of the disclosure, the time lag identifier (102) of system 100 further comprises the domain knowledge database (206) that is configured for sharing dynamically updated domain knowledge with the time lag identifier. The domain knowledge database (206) is dynamically updated with exhaustive domain knowledge an industry for which time lag is being identified. The domain knowledge database (206) comprises of exhaustive details regarding possible groups that can be identified based on domain knowledge of a plurality of industries, the maximum number of time lags to be created and checked in the identification approach, etc.,

According to an embodiment of the disclosure, the time lag identifier (102) of the system 100 further comprises the grouping module (208) configured for identifying presence of groups among the plurality of pre-processed data based on a plurality of domain knowledge and a plurality of data based techniques. The grouping module (208) further comprises of the domain knowledge grouping unit (210) configured for identifying the presence of groups among the plurality of pre-processed data based on a plurality of domain knowledge that is received from the domain knowledge (206) database and the data based technique unit (212) configured for identifying the presence of groups among the plurality of pre-processed data based a plurality of data based techniques.

In an embodiment, the domain knowledge for grouping of pre-processed data that is performed in the domain knowledge grouping unit (210) is based on several criteria that include an enterprise hierarchy and type of the received data, wherein the enterprise hierarchy comprises plant wise, unit wise, equipment wise, location of sensor and any other levels and the type of received data further comprises raw material, process parameters and instrument type. Further the raw material further includes of composition, feed, quality & state, the process parameters further includes of temperature, pressure and flow rate.

In an embodiment, the data-based techniques for grouping of pre-processed data that is performed in the data-based technique unit (212) is based on several techniques that include correlation, clustering and several other known data-based techniques.

Table 1 shows a use case example of identifying groups for pre-processed data based on a plurality of domain knowledge and a plurality of data-based techniques;

TABLE 1
Group identification

| Pre-processed | Group | |
|---|---|---|
| data | Identified | Type of group |
| P1 | G1 | Plant wise |
| P2 | G1 | Plant wise |
| P3 | G2 | Raw material - Feed + Correlation |
| P4 | G2 | Raw material - Feed + Correlation |
| P5 | G3 | Others/individual |
| P6 | G4 | Process parameter - temperature |
| P7 | G4 | Process parameter - temperature |
| P8 | G4 | Process parameter - temperature |
| P9 | — | No lag identification required |
| . . . | | |
| Pn | Gm | Clustering |

Table 2 shows another use case example of identifying groups for pre-processed data based on a plurality of domain knowledge and a plurality of data-based techniques;

TABLE 2
Group identification

| Pre-processed | Group | |
|---|---|---|
| data | Identified | Type of group |
| Coke quality | G1 | Quality & location |
| Sinter quality | G1 | Quality & location |
| Pellet quality | G2 | Data based |
| Pressure | G2 | Data based |
| Temperature | G3 | Others/individual |

According to an embodiment of the disclosure, the time lag identifier (102) of the system 100 further comprises the feature selection module (214) configured for selecting a set of parameters from the grouped plurality of data based on the domain knowledge and data based techniques using feature selection techniques, wherein the selected set of parameters are represented as numerical data. The feature selection is implemented based on a plurality of techniques that include correlation techniques, statistics and machine learning techniques followed by ranking and consolidation. The feature selection is performed using multiple techniques including but not limited to Support vector regression (SVR), Random forest regression (RF), Linear regression (LR), Ridge regression, Lasso regression, Extra tree regression (ETR), Mutual info regression (MIR). Further an overall score is computed based on individual scores obtained from different techniques to selecting a set of parameters.

In an embodiment, considering an example parameter—“gas temperature” that has been grouped based on “location” for implementing feature selection. The feature selection techniques that include atleast one of Support vector regression (SVR), Random forest regression (RF), Linear regression (LR), Ridge regression, Lasso regression, Extra tree regression (ETR), Mutual info regression (MIR) is applied and a score is generated for each technique as shown in the table below;

TABLE 3
Feature selection

| | Gas | Gas | Gas | Gas | Gas |
|---|---|---|---|---|---|
| | temper- | temper- | temper- | temper- | temper- |
| | ature | ature | ature | ature | ature |
| | at | at | at | at | at |
| Top Lag | location | location | location | location | location |
| technique | 1 | 2 | 3 | 4 | 5 |
| 1 | 0 | 0 | 0 | 0 | 3 |
| 2 | 2 | 2 | 2 | 0 | 0 |

Finally, considering the top results, an overall score is computed based on individual scores by giving maximum weightage to the top lag technique. In the above example the time lag of gas temperature is estimated to be “0” considering maximum value repeated in the top lag technique.

According to an embodiment of the disclosure, the time lag identifier (102) of the system 100 further comprises the time lag identification module (216) identifying at least one time lag parameter from the selected set of parameters based on at least one of a plurality of time lag identification techniques that are selected based a user requirement, wherein the plurality of time lag identification techniques are an individual time lag identification technique, a group-wise time lag identification technique and group-wise/individual time lag identification technique. The time lag identification module (216) further comprises of the individual time lag identification unit (218) configured for individual time lag identification, the group-wise time lag identification unit (220) configured for the group-wise time lag identification and the group-wise/individual time lag identification unit (222) configured for the group-wise/individual time lag identification.

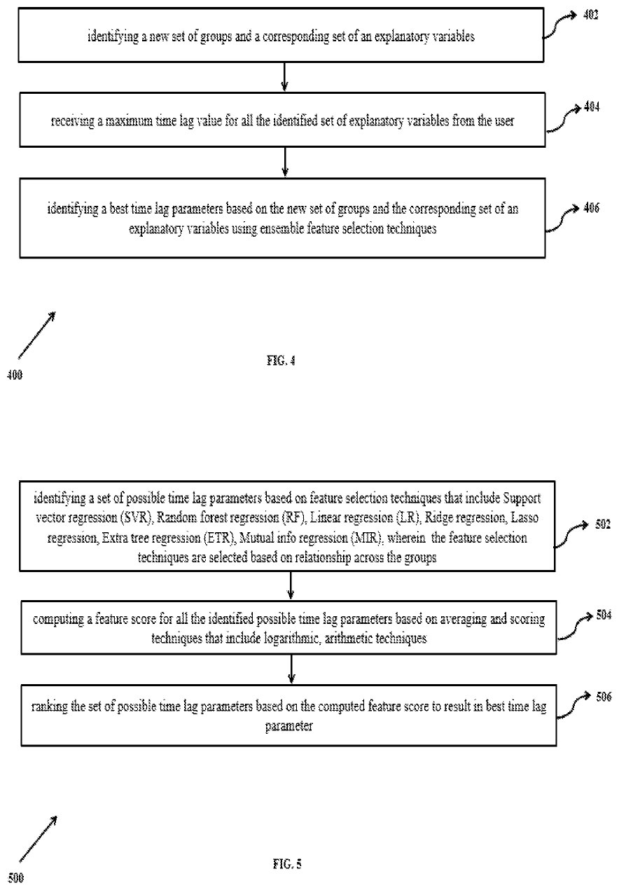

In an embodiment, the time lag identification module (216) further comprises of the individual time lag identification unit (218) configured for individual time lag identification. The step of individual time lag identification technique depicted in FIG. 4 as a flow diagram:

At step 402, a new set of groups and a corresponding set of an explanatory variables is identified. The new set of groups identified are represented as (G₁, G₂ . . . Gₘₙ) and the explanatory variables identified are represented as (Vᵢ₁, Vᵢ₂ . . . V_{iGn}) wherein Gᵢ is total number of variable in any group “i” . In an embodiment, the new set of groups are identified/selected one by one in a sequence using a loop to further identify time lag.

At the next step 404, a maximum time lag value is received for all the identified set of explanatory variables from the user. The maximum time lag value is represented as lagₘₐₓ.

At the next step 406, a best time lag parameter is identified based on the new set of groups and the corresponding set of an explanatory variables using ensemble feature selection techniques. Inside a group, the explanatory variables are selected one by one and lags are created from 1 to lagₘₐₓ. Further individually for each variable with lagₘₐₓ₊₁ created features, ensemble feature selection is performed using multiple techniques that is explained below.

In an embodiment, the step of ensemble feature selection techniques depicted in

FIG. 5 as a flow diagram:

At step 502, a set of possible time lag parameters are identified based on feature selection techniques that include Support vector regression (SVR), Random forest regression (RF), Linear regression (LR), Ridge regression, Lasso regression, Extra tree regression (ETR), Mutual info regression (MIR), wherein the feature selection techniques are selected based on relationship across the groups. In an embodiment, set of possible time lag parameters are identified for groups based on a common score.

At the next step 504, a feature score is computed for all the identified possible time lag parameters based on averaging and scoring techniques that include logarithmic, arithmetic techniques. The feature score is computed for all the identified possible time lag parameters based on feature selection techniques (step 502). Further a logarithmic sum of the feature scores is computed to obtain a final score corresponding to each time lag created.

At the next step 506, the set of possible time lag parameters are ranked based on the computed feature score to result in best time lag parameter. In an embodiment the feature scores are ranked based on well-known ranking algorithms that include a simple sorting process wherein top scoring feature scores are picked as the best time lag.

In an embodiment, the time lag identification module (216) further comprises of the group-wise time lag identification unit (220) configured for the group-wise time lag identification. The group-wise time lag identification is performed separately for all the groups.

In an embodiment, a use case example for individual time lag identification is explained by considering an example parameter—“pressure” that has been grouped based on “location”. The feature selection techniques that include atleast one of Support vector regression (SVR), Random forest regression (RF), Linear regression (LR), Ridge regression, Lasso regression, Extra tree regression (ETR), Mutual info regression (MIR) is applied and a score is generated for each technique as shown in the table below;

TABLE 4
Feature selection for pressure parameter

| Top Lag | Pressure at | Pressure at | Pressure at | Pressure at | Pressure at |
|---|---|---|---|---|---|
| technique | location 1 | location 2 | location 3 | location 4 | location 5 |
| 1 | 0 | 0 | 0 | 0 | 3 |
| 2 | 2 | 2 | 2 | 0 | 0 |

Finally, considering the top results, an overall score is computed based on individual scores. In the above example the time lag of pressure is estimated to be “0”. Further the same process is performed for several parameters to estimate time lag as shown in the table below;

TABLE 5
Individual time lag identification

| | Time Lag |
|---|---|
| Parameter | identified |
| Solution loss carbon | 0 |
| Production rate | 0 |
| Pressure at location 1 | 0 |
| Sinter basicity | 18 |
| Coke rate | 8 |
| Permeability at middle | 0 |
| Overall permeability | 0 |
| Input charge weight at location 3 | 9 |
| MnO in Pellet | 15 |
| Pressure at location 2 | 0 |
| Raceway adiabatic flame temperature | 0 |
| Humidity of cold blast | 0 |
| Ash in coke | 10 |
| Bosh gas volume | 0 |
| Sulphur in Sinter | 18 |
| K2O in Sinter | 18 |
| Coal rate | 0 |
| Above burden temperature | 0 |
| Alpha by Beta | 9 |
| TiO2 in Sinter | 18 |

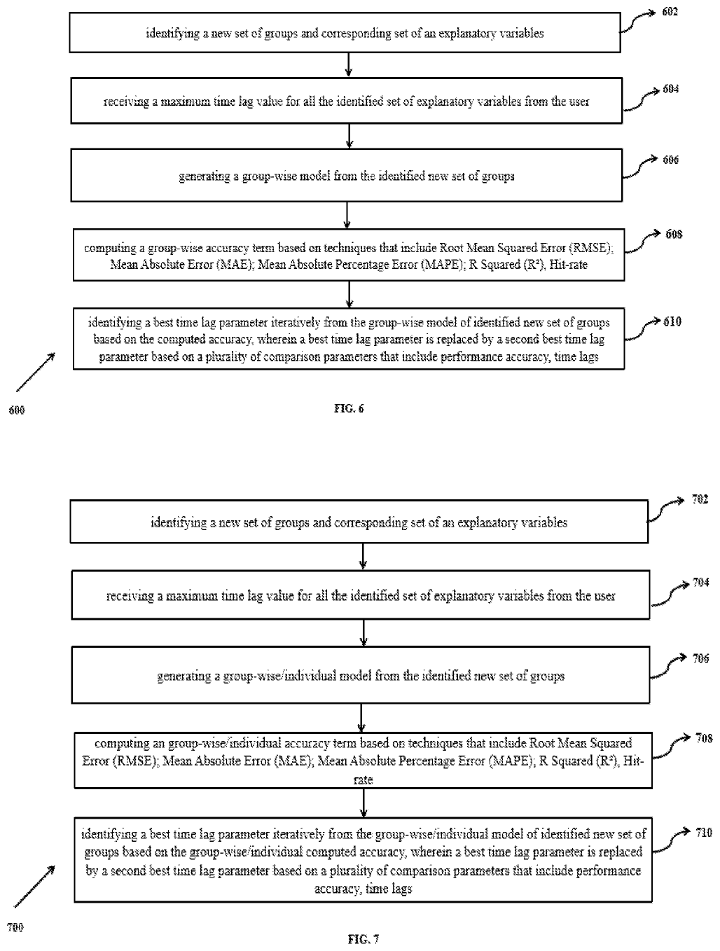

The step of group-wise time lag identification technique depicted in FIG. 6 as a flow diagram:

At step 602, a new set of groups and a corresponding set of an explanatory variables are identified. The new set of groups identified are represented as (G₁, G₂ . . . Gₙ) and the explanatory variables identified are represented as (Vᵢ₁, Vᵢ₂ . . . Gₙ) wherein Gᵢ is total number of variable in any group “i” .Further for scenarios where just one variable is present inside a group, then the single variable is itself considered as a group with just one member and best time-lag is identified in the similarly to groups with multi-variables. The groups and variables inside are selected based on the grouping approach and then are taken one by one for lag identification in a loop.

At the next step 604, a maximum time lag value is received for all the identified set of explanatory variables from the user. The maximum time lag value is represented as lag_{max.}

At the next step 606, a group-wise model is identified from the identified new set of groups. The group-wise time lag identification is performed separately for all the groups. Hence a group is first considered with all variables and lags are created from 0 to lagₘₐₓ to build a predictive model referred to as group-wise model. The group-wise model is built separately for all the time lags using machine learning or statistical technique that include Support vector machines and Random forest. First a base group-wise model corresponding to time lags is built in the beginning and hypothetically considered as the best model

At the next step 608, a group-wise accuracy term is computed using techniques that include Root Mean Squared Error (RMSE); Mean Absolute Error (MAE); Mean Absolute Percentage Error (MAPE); R Squared (R²), Hit-rate(608).

In an embodiment, the group-wise accuracy term is computed as per individual definitions that include an actual and a predicted value. Further the group-wise accuracy term is computed for every time lag parameter created as the model is built for each time lag parameter . An example of Root Mean Square Error (RMSE) technique for computing the group-wise accuracy term is shown below;

$$RMSE = \sqrt{\frac{{\sum }_{i = 1}^{N} {( {Predicted}_{i} - {Actual}_{i} )}^{2}}{N}}$$

At the next step 610, a best time lag parameter is identified from the group-wise model of identified new set of groups based on the computed group-wise accuracy, wherein at least a best time lag parameter is identified for all the groups in the new set of groups. The base group-wise model first built corresponding to 0 time lags (hypothetically considered best) is compared iteratively with the second group-wise model for other lags and replaced with the group-wise model with the better performance. At the end of the iteration in the best group-wise model corresponding to a time-lag for that group is obtained and lag identification process moves on to the next group. The above steps are repeated for all the groups to obtain time-lags separately for all the groups and its variables.

In an embodiment, a use case example for group-wise time lag identification is illustrated based on the tables below. As explained above, groups are created, a group-wise model is identified, and a group-wise accuracy term is computed as shown in table 6 below;

TABLE 6
Groupwise accuracy term

| | | Groupwise |
|---|---|---|
| | | accuracy |
| Group 1 | Variables (time lag) for model (SVM) | term |
| Time | TEMP_1 (0), TEMP_1 (0), TEMP_2 (0), TEMP_3 | 0.974409 |
| lag 0 | (0), TEMP_4 (0), TEMP_AVG (0) | |
| Time | TEMP_1 (1), TEMP_1 (1), TEMP_2 (1), TEMP_3 | 0.98898 |
| lag 1 | (1), TEMP_4 (1), TEMP_AVG (1) | |
| Time | TEMP_1 (2), TEMP_1 (2), TEMP_2 (2), TEMP_3 | 0.98992 |
| lag 2 | (2), TEMP_4 (2), TEMP_AVG 2) | |
| Time | TEMP_1 (3), TEMP_1 (3), TEMP_2 (3), TEMP_3 | 0.97982 |
| lag 3 | (3), TEMP_4 (3), TEMP_AVG (3) | |
| Time | TEMP_1 (4), TEMP_1 (4), TEMP_2 (4), TEMP_3 | 0.99112 |
| lag 4 | (4), TEMP_4 (4), TEMP_AVG (4) | |

Further a best time lag parameter is identified from the group-wise model of identified new set of groups based on the computed group-wise accuracy, wherein at least a best time lag parameter is identified for all the groups in the new set of groups as shown below in table 7

TABLE 7
Groupwise time lag identification

| | No. of | | | | | | |
|---|---|---|---|---|---|---|---|
| Group | Vars | Lag_max | Best_Lag | RMSE-1 | Second_Best | RMSE-2 | Variables |
| 1 | 5 | 25 | 0 | 0.974409 | 3 | 0.97982 | TEMP_1, 2, |
| | | | | | | | 3, 4, AVG |
| 2 | 25 | 25 | 8 | 0.884304 | 3 | 0.896894 | Coke weight, |
| | | | | | | | Metal weight, |
| | | | | | | | coke rate, |
| | | | | | | | Ore/coke |
| 3 | 10 | 25 | 9 | 0.894683 | 12 | 0.894728 | Coke |
| | | | | | | | chemical |
| | | | | | | | composition, |
| | | | | | | | size, etc. |
| | | | | | | | variables |
| 4 | 15 | 36 | 18 | 0.85674 | 0 | 0.861546 | Sinter |
| | | | | | | | chemical |
| | | | | | | | composition, |
| | | | | | | | size, etc. |
| | | | | | | | variables |
| 5 | 28 | 36 | 15 | 0.784075 | 9 | 0.784941 | Pellet Coke |
| | | | | | | | chemical |
| | | | | | | | composition, |
| | | | | | | | size, etc. |
| | | | | | | | variables |

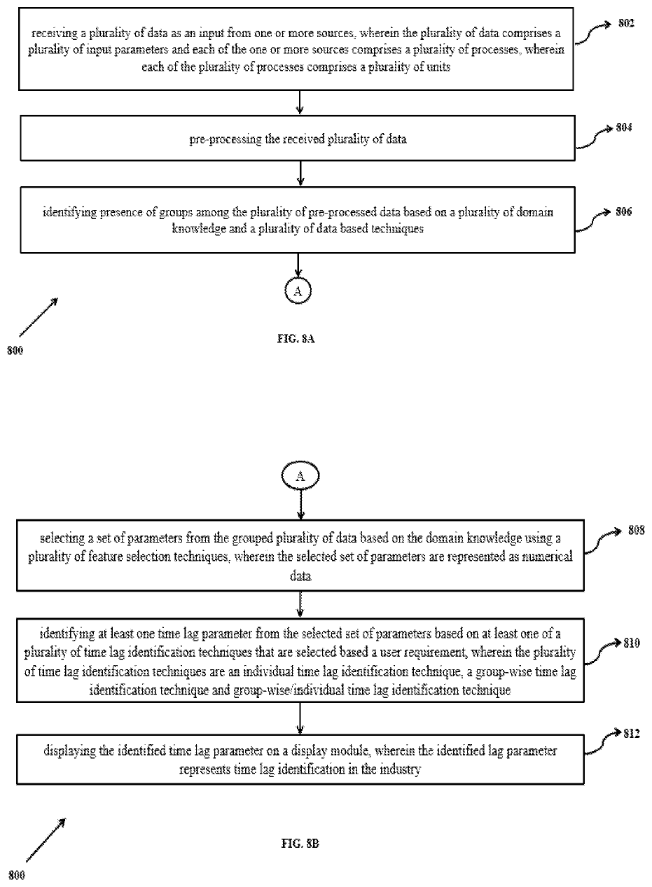

In an embodiment, the time lag identification module (216) further comprises of the group-wise/individual time lag identification unit (222) configured for the group-wise/individual time lag identification. The step of group-wise/individual time lag identification technique depicted in FIG. 7 as a flow diagram:

At step 702, a new set of groups and a corresponding set of an explanatory variables are identified. The new set of groups identified are represented as (G₁, G₂ . . . Gₙ) and the explanatory variables identified are represented as (Vᵢ₁, Vᵢ₂ . . . Gₙ) wherein Gᵢ is total number of variable in any group “i” . Further for scenarios where just one variable is present inside a group, then the single variable is itself considered as a group with just one member and best time-lag is identified in the similarly to groups with multi-variables. The groups and variables inside are selected based on the grouping approach and then are taken one by one for lag identification in a loop.

At the next step 704, a maximum time lag value is received for all the identified set of explanatory variables from the user. The maximum time lag value is represented as lagₘₐₓ.

At the next step 706, a group-wise/individual model is generated from the identified new set of groups. The group-wise/individual time lag identification is performed separately for all the groups and its individual variables. Hence a group is first considered with all variables and lags are created from 0 to lagₘₐₓ to build a predictive model referred to as group-wise//individual model. The group-wise/individual model is built separately for all the time lags using well known machine learning or statistical technique that include Support vector machines and Random forest. First a base group-wise model corresponding to time lags is built in the beginning and hypothetically considered as the best model.

At the next step 708, an group-wise/individual accuracy term is computed based on techniques that include Root Mean Squared Error (RMSE); Mean Absolute Error (MAE); Mean Absolute Percentage Error (MAPE); R Squared (R²), Hit-rate (708). In an embodiment, the group-wise/individual accuracy term is computed as per individual definitions that include an actual and a predicted value. Further group-wise/individual accuracy term is computed for every time lag parameter created as the a model is built for each time lag parameter. An example of Root Mean Square Error (RMSE) technique for computing the group-wise/individual accuracy term is shown below;

$$RMSE = \sqrt{\frac{{\sum }_{i = 1}^{N} {( {Predicted}_{i} - {Actual}_{i} )}^{2}}{N}}$$

At the next step 710, a best time lag parameter is identified iteratively from the group-wise/individual model of identified new set of groups based on the computed group-wise/individual accuracy, wherein a best time lag parameter is replaced by a second best time lag parameter based on a plurality of comparison parameters that include performance accuracy, time lags. The base group-wise/individual model first built corresponding to time lags (hypothetically considered best) is compared iteratively with the second group-wise/individual model for other lags as well as other groups and replaced with the group-wise model/individual with the better performance. At the end of the iteration (comparison within group as well as with other groups) the best group-wise model/individual corresponding to a time-lag for that group is obtained and time lag identification process moves on to the next group. The above steps are repeated for all the groups to obtain time-lags separately for all the groups and its variables. The best time lag is identified based on the model performance score which are measured based on RMSE, MAE, MAPE, etc. The lowest error score will correspond to the best time lag for that group and its explanatory variables.

In an embodiment, a use case example for group-wise/individual time lag identification is illustrated based on the tables below. As explained above, groups are created, group-wise/individual model is identified and a group-wise/individual accuracy term is computed as shown in table 8 below;

TABLE 8
Groupwise/individual accuracy term

| | | Group-wise/ |
|---|---|---|
| Iterations | | individual |
| (no. of | Variables (time lag) for model (SVM) - all | accuracy |
| groups) | groups together | term |
| 0 | Coke_Ash(0), Coke VM(0), Coke_Moisture(0), | 0.99711 |
| | Coke_Size(0), Coke_MnO(0), | |
| | Gas_input_temp(0), Gas_input_pressure(0), | |
| | Sinter_FeO(0), Sinter_Cr2O3(0), Sinter_size(0), | |
| | Process parameters(0) | |
| 1 | Coke_Ash(8), Coke VM(8), Coke_Moisture(8), | 0.974409 |
| | Coke_Size(0), Coke_MnO(0), | |
| | Gas_input_temp(0), Gas_input_pressure(0), | |
| | Sinter_FeO(0), Sinter_Cr2O3(0), Sinter_size(0), | |
| | Process parameters(0) | |
| 2 | Coke_Ash(8), Coke VM(8), Coke_Moisture(8), | 0.93498 |
| | Coke_Size(8), Coke_MnO(8), | |
| | Gas_input_temp(0), Gas_input_pressure(0), | |
| | Sinter_FeO(0), Sinter_Cr2O3(0), Sinter_size(0), | |
| | Process parameters(0) | |
| 3 | Coke_Ash(8), Coke VM(8), Coke_Moisture(8), | 0.89992 |
| | Coke_Size(8), Coke_MnO(8), | |
| | Gas_input_temp(0), Gas_input_pressure(0), | |
| | Sinter_FeO(0), Sinter_Cr2O3(0), Sinter_size(0), | |
| | Process parameters(0) | |
| 4 | Coke_Ash(8), Coke VM(8), Coke_Moisture(8), | 0.88982 |
| | Coke_Size(8), Coke_MnO(8), | |
| | Gas_input_temp(0), Gas_input_pressure(0), | |
| | Sinter_FeO(9), Sinter_Cr203(9), Sinter_size(9), | |
| | Process parameters(0) | |
| 5 | Coke_Ash(8), Coke VM(8), Coke_Moisture(8), | 0.84112 |
| | Coke_Size(8), Coke_MnO(8), | |
| | Gas_input_temp(0), Gas_input_pressure(0), | |
| | Sinter_FeO(9), Sinter_Cr203(9), Sinter_size(9), | |
| | Process parameters(9) | |

Further a best time lag parameter is identified iteratively from the group-wise/individual model of identified new set of groups based on the computed group-wise/individual accuracy, wherein a best time lag parameter is replaced by a second best time lag parameter based on a plurality of comparison parameters that include performance accuracy, time lags as shown below in table 9

TABLE 9
group-wise/individual time lag identification

| | | | | Group- | |
|---|---|---|---|---|---|
| | | | | wise/ | |
| | No. of | | | individual | |
| | vari- | Lag_ | Best_ | accuracy | |
| Group | ables | max | Lag | term | Variables |
| 1 | 3 | 10 | 8 | 0.974409 | Coke_Ash, |
| | | | | | Coke VM, |
| | | | | | Coke_Moisture |
| 2 | 5 | 10 | 8 | 0.93498 | Coke_Size, |
| | | | | | Coke_MnO, etc. |
| 3 | 2 | 10 | 0 | 0.89992 | Gas_input_temp, |
| | | | | | Gas_input_ |
| | | | | | pressure |
| 4 | 6 | 10 | 9 | 0.88982 | Sinter_FeO, |
| | | | | | Sinter_Cr2O3, |
| | | | | | Sinter_size, etc. |
| 5 | 10 | 10 | 2 | 0.84112 | Process |
| | | | | | parameters |
| | | | | | inside blast |
| | | | | | furnace |

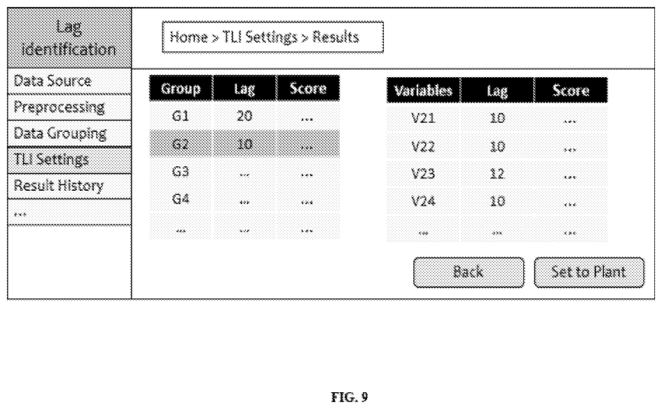

According to an embodiment of the disclosure, the time lag identifier (102) of the system 100 further comprises the display module (224) configured for displaying the identified time lag parameter on a display module, wherein the identified time lag parameter represents time lag identification in the industry. In an embodiment, FIG. 9 illustrates a use case example of the display module (224), wherein the table on left side illustrates time lags identified for each of the group while the table on right shows the lags identified for individual parameters for highlighted group.

FIG. 8A and FIG. 8B, with reference to FIGS. 1-2, is an exemplary flow diagram illustrating a method for time lag identification in an industry using the system 100 of FIG. 1 according to an embodiment of the present disclosure. The steps of the method of the present disclosure will now be explained with reference to the components of the time lag identifier (102) of the system 100 and the modules (202-224) as depicted in FIGS. 1-2, and the flow diagram as depicted in FIG. 8A and FIG. 8B.

At step 802, includes receiving a plurality of data as an input from one or more sources at the input module (202), wherein the plurality of data comprises a plurality of input parameters and each of the one or more sources comprises a plurality of plants, wherein each of the plurality of plants comprises a plurality of units as shown in FIG. 1. The received data from one or more sources comprise a plurality of parameters that include raw materials quality-composition, process parameters, product quality, production amount, equipment condition and effluents for each source, plant or unit.

In the next step at 804, includes pre-processing the received plurality of input data and the plurality of real-time input data in the pre-processing module (204). In an embodiment step of pre-processing includes removing outliers and replacing missing input data based on multi-level outlier model and clustering classification respectively.

In the next step at 806, includes identifying presence of groups among the plurality of pre-processed data based on a plurality of domain knowledge and a plurality of data-based techniques in the grouping module (208. The grouping module (208) further comprises of the domain knowledge grouping unit (210) configured for identifying the presence of groups among the plurality of pre-processed data based on a plurality of domain knowledge that is received from the domain knowledge (206) database and the data based technique unit (212) configured for identifying the presence of groups among the plurality of pre-processed data based a plurality of data based techniques.

In the next step at 308, selecting a set of parameters in the feature selection module (214) from the grouped plurality of data based on the domain knowledge using a plurality of feature selection techniques, wherein the selected set of parameters are represented as numerical data.

In the next step at 310, includes identifying at least one time lag parameter from the selected set of parameters in the time lag identification module (216) based on at least one of a plurality of time lag identification techniques that are selected based a user requirement, wherein the plurality of time lag identification techniques are an individual time lag identification technique, a group-wise time lag identification technique and group-wise/individual time lag identification technique. The time lag identification module (216) further comprises of the individual time lag identification unit (218) configured for individual time lag identification, the group-wise time lag identification unit (220) configured for the group-wise time lag identification and the group-wise/individual time lag identification unit (222) configured for the group-wise/individual time lag identification.

In the next step at 312, includes displaying the identified time lag parameter on a display module (224), wherein the identified lag parameter represents time lag identification in the industry.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

Hence a method and a system for time lag identification in an industry is provided. The disclosure proposes to monitor an industry continuously at real time to identify at least one or more parameters from plurality of sources (processes/units/plants) that cause a time delay or delayed performance or functional impact on a plurality of Key Performance Indicator (KPI). The proposed time lag identification is performed using one-time lag identification from the proposed plurality of time lag identification techniques that include an individual time lag identification technique, a group-wise time lag identification technique and group-wise/individual time lag identification technique. Further the time lag identification is performed based on domain knowledge as well as data driven techniques.

It is to be understood that the scope of the protection is extended to such a program and in addition to a computer-readable means having a message there in; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

1. A processor-implemented method for time lag identification in an industry in the method comprising:
receiving a plurality of data as an input from one or more sources, via one or more hardware processors, wherein the plurality of data comprises a plurality of input parameters and each of the one or more sources comprises a plurality of plants, wherein each of the plurality of plants comprises a plurality of units;
pre-processing, via the hardware processors, the received plurality of data;
identifying presence of groups among the plurality of pre-processed data, via the hardware processors, based on a plurality of domain knowledge and a plurality of data-based techniques;
selecting a set of parameters from the grouped plurality of data, via the hardware processors, based on the domain knowledge using a plurality of feature selection techniques, wherein the selected set of parameters are represented as numerical data;
identifying at least one time lag parameter from the selected set of parameters, via the hardware processors, based on at least one of a plurality of time lag identification techniques that are selected based a user requirement, wherein the plurality of time lag identification techniques are an individual time lag identification technique, a group-wise time lag identification technique and group-wise/individual time lag identification technique; and
displaying the identified time lag parameter on a display module, via the hardware processors, wherein the identified lag parameter represents time lag identification in the industry.

2. The method of claim 1, wherein the time lag identification refers to identification of one or more parameters and a time delay or delayed performance or functional impact the identified parameter has on a plurality of Key Performance Indicator (KPI) and comprises of a plurality of parameters that include processing time, reaction time, transportation lag from one unit to other units, response time of sensors, residence time of raw materials at yards.

3. The method of claim 1, wherein the received data from one or more sources comprise a plurality of parameters that include raw materials quality-composition, process parameters, product quality, production amount, equipment condition and effluents for each source, plant or unit.

4. The method of claim 1, wherein the step of pre-processing of the received plurality of data includes removing outliers-noises and replacing missing received data based on multi-level outlier model and clustering classification techniques respectively.

5. The method of claim 1, wherein the domain knowledge for grouping of pre-processed data is based on several criteria that include an enterprise hierarchy and type of the received data, wherein the enterprise hierarchy comprises plant wise, unit wise, equipment wise, location of sensor and any other levels and the type of received data further comprises raw material, process parameters and instrument type.

6. The method of claim 1, wherein the data-based techniques for grouping of pre-processed data is based on several techniques that include correlation, clustering and several other known data based techniques.

7. The method of claim 1, wherein the step of individual time lag identification technique further comprising:
identifying a new set of groups and a corresponding set of an explanatory variables;
receiving a maximum time lag value for all the identified set of explanatory variables from the user; and
identifying a best time lag parameter based on the new set of groups and the corresponding set of an explanatory variables using ensemble feature selection techniques.

8. The method of claim 7, wherein the ensemble feature selection techniques further includes:
identifying a set of possible time lag parameters based on feature selection techniques that include Support vector regression (SVR), Random forest regression (RF), Linear regression (LR), Ridge regression, Lasso regression, Extra tree regression (ETR), Mutual info regression (MIR), wherein the feature selection techniques are selected based on relationship across the groups;
computing a feature score for all the identified possible time lag parameters based on averaging and scoring techniques that include logarithmic, arithmetic techniques; and
ranking the set of possible time lag parameters based on the computed feature score to result in best time lag parameter.

9. The method of claim 1, wherein the step of group-wise time lag identification technique further comprising:
identifying a new set of groups and a corresponding set of an explanatory variables;
receiving a maximum time lag value for all the identified set of explanatory variables from the user;
generating a group-wise model from the identified new set of groups;
computing a group-wise accuracy term using techniques that include Root Mean Squared Error (RMSE); Mean Absolute Error (MAE); Mean Absolute Percentage Error (MAPE); R Squared (R²), Hit-rate; and
identifying a best time lag parameter from the group-wise model of identified new set of groups based on the computed group-wise accuracy, wherein at least a best time lag parameter is identified for all the groups in the new set of groups.

10. The method of claim 1, wherein the step of group-wise/individual time lag identification technique further includes:
identifying a new set of groups and corresponding set of an explanatory variables;
receiving a maximum time lag value for all the identified set of explanatory variables from the user;
generating a group-wise/individual model from the identified new set of groups;
computing a group-wise/individual accuracy term based on techniques that include Root Mean Squared Error (RMSE); Mean Absolute Error (MAE);
Mean Absolute Percentage Error (MAPE); R Squared (R²), Hit-rate; and
identifying a best time lag parameter iteratively from the group-wise/individual model of identified new set of groups based on the computed group-wise/individual accuracy, wherein a best time lag parameter is replaced by a second best time lag parameter based on a plurality of comparison parameters that include performance accuracy, time lags.

11. A system for time lag identification in an industry, the system comprising:
an input module configured for receiving a plurality of data as an input from one or more sources, via the hardware processors, wherein the plurality of data comprises a plurality of input parameters and each of the one or more sources comprises a plurality of plants, wherein each of the plurality of plants comprises a plurality of units;
a pre-processing module configured for pre-processing the received plurality of data;
a grouping module configured for identifying presence of groups among the plurality of pre-processed data based on a plurality of domain knowledge and a plurality of data-based techniques;
a feature selection module configured for selecting a set of parameters from the grouped plurality of data based on the domain knowledge and data-based techniques using feature selection techniques, wherein the selected set of parameters are represented as numerical data;
a time lag identification module identifying at least one time lag parameter from the selected set of parameters based on at least one of a plurality of time lag identification techniques that are selected based a user requirement, wherein the plurality of time lag identification techniques are an individual time lag identification technique, a group-wise time lag identification technique and group-wise/individual time lag identification technique; and
a display module configured for displaying the identified time lag parameter on a display module, wherein the identified time lag parameter represents time lag identification in the industry.

12. The system of claim 11, wherein a plurality of domain knowledge is obtained from a domain knowledge database that is configured for sharing dynamically updated domain knowledge of an industry for which time lag is being identified.

13. The system of claim 11, wherein the grouping module further comprises of an domain knowledge grouping unit configured for identifying the presence of groups among the plurality of pre-processed data based on a plurality of domain knowledge that is received from the domain knowledge database and a data based technique unit configured for identifying the presence of groups among the plurality of pre-processed data based a plurality of data based techniques.

14. The system of claim 11, wherein the time lag identification module further comprises of an individual time lag identification unit configured for individual time lag identification, a group-wise time lag identification unit configured for the group-wise time lag identification and a group-wise/individual time lag identification unit configured for the group-wise/individual time lag identification.

15. A non-transitory computer-readable medium having embodied thereon a computer readable program for time lag identification in an industry wherein the computer readable program, when executed by one or more hardware processors, cause:
receiving a plurality of data as an input from one or more sources, via the hardware processors, wherein the plurality of data comprises a plurality of input parameters and each of the one or more sources comprises a plurality of plants, wherein each of the plurality of plants comprises a plurality of units;
pre-processing, via the hardware processors, the received plurality of data;
identifying presence of groups among the plurality of pre-processed data, via the hardware processors, based on a plurality of domain knowledge and a plurality of data-based techniques;
selecting a set of parameters from the grouped plurality of data, via the hardware processors, based on the domain knowledge using a plurality of feature selection techniques, wherein the selected set of parameters are represented as numerical data;
identifying at least one time lag parameter from the selected set of parameters, via the hardware processors, based on at least one of a plurality of time lag identification techniques that are selected based a user requirement, wherein the plurality of time lag identification techniques are an individual time lag identification technique, a group-wise time lag identification technique and group-wise/individual time lag identification technique; and
displaying the identified time lag parameter on a display module, via the hardware processors, wherein the identified lag parameter represents time lag identification in the industry.
